(19) United States
(12) Patent Application Publication
(10) Pub. No.: US 2017/0013858 A1
(43) Pub. Date: Jan. 19, 2017

(54) Process for Obtaining Lean Protein

(71) Applicant: Proteus Industries, Inc., Gloucester, MA (US)

(72) Inventors: Stephen D Kelleher, Ipswich, MA (US); William R. Fielding, Hilton Head, SC (US)

(21) Appl. No.: 15/217,984

(22) Filed: Jul. 23, 2016

Related U.S. Application Data
(63) Continuation-in-part of application No. 14/872,279, filed on Oct. 1, 2015.
Application No. 14/872,279 is a continuation of application No. 13/374,077, filed on Dec. 12, 2011, now Pat. No. 9,161,555.
Application No. 13/374,077 is a continuation-in-part of application No. 14/506,615, filed on Oct. 4, 2014.
Application No. 14/506,615 is a continuation-in-part of application No. 13/374,398, filed on Dec. 28, 2011.
(60) Provisional application No. 61/460,324, filed on Jan. 3, 2011.
(60) Provisional application No. 61/886,889, filed on Oct. 4, 2013.

(51) Int. Cl. A23J 1/02; A23J 3/00

(52) U.S. Cl. CPC A23J 1/02; A23J 3/04

(57) ABSTRACT

A protein fraction and an oxidation stable fat fraction are recovered from meat trimmings or a high fat content animal muscle tissue. The trimmings are comminuted, and solubilized with a food grade acid or base. The solubilized protein/fat solution is heated so that the fat transforms into a liquid state. The protein is precipitated and the liquid fat is separated. The process results in a lean protein product that is red in color and can also have characteristics of functional meat.

### REFERENCE TO RELATED APPLICATION

This application is a continuation-in-part of U.S. application Ser. No. 14/872,279, entitled, “Protein Composition Obtained From Meat Trimmings” by Stephen D. Kelleher, et al., filed Oct. 1, 2015, which is a continuation of U.S. application Ser. No. 13/374,077, now U.S. Pat. No. 9,161,555, entitled, “Process for isolating a protein composition and a fat composition from meat trimmings” by Stephen D. Kelleher, et al., filed Dec. 12, 2011, and this application is a continuation-in-part of U.S. application Ser. No. 13/374,398, entitled, “Process for isolating a protein composition and a fat composition from mechanically deboned poultry” by Stephen D. Kelleher, et al., filed Dec. 28, 2011, which both claim the benefit of U.S. Provisional Application No. 61/460,324, entitled, “Process for isolating a protein composition and a fat composition from meat trimmings” by Stephen D. Kelleher et al., filed Jan. 3, 2011; and this application is a continuation-in-part of U.S. application Ser. No. 14/506,615, entitled “Functional Protein Derived from Animal Muscle Tissue or Mechanically Deboned Meat and Method for Making the Same,” by Stephen D. Kelleher et al., filed Oct. 4, 2014, which claims the benefit of U.S. Provisional Application No. 61/886,889, entitled “Protein Derived from Animal Muscle Tissue or Mechanically Deboned Meat and Method for Making the Same Using Food Preservation Methods” by Stephen D. Kelleher et al., filed Oct. 4, 2013.

The entire teachings of the above applications are incorporated herein by reference.

### FIELD OF THE INVENTION

This invention relates to a process for isolating a protein composition and a stable fat composition from a fatty animal muscle source such as meat trimmings or animal muscle tissue having an average fat content between about 50% and 85% by weight and a lean content between about 50% and about 15% by weight. More particularly, this invention relates to such a process wherein the animal muscle tissue is solubilized in an acid or base, heated to a temperature less than 107° F. such that the fat transforms from a solid state into a liquid form, the protein is precipitated and the liquid fat is separated from the protein to obtain an uncooked, lean precipitated protein composition having 14% or greater by weight protein and less than 30% by weight fat and a red color, or a color of 75 to 52 L*, 32 to 15 a*, and 23 to 7 b*, (e.g., 75 to 52 L*, 25 to 15 a*, and 23 to 16 b*).

### DESCRIPTION OF PRIOR ART

At the present time, protein recovered from animal muscle tissue is obtained by solubilizing the animal muscle tissue in an edible acidic composition such as citric acid, hydrochloric acid or mixtures thereof. Such processes are disclosed in U.S. Pat. Nos. 6,005,073; 6,288,216; 6,451,975 and 7,473,764. While these processes are well adapted for recovering protein from animal muscle tissue using pHs below 3.5, they are not well adapted for recovering, with high efficiency, protein and fat from meat trimmings or meat with high fat contents. These meat trimmings contain a high concentration of animal muscle tissue, typically between 30-50% by weight of the trimmings with the remaining composition comprising primarily fat. Thus, it is desirable to recover the protein from the animal muscle tissue for use as a food additive rather than discarding it. It is also desirable to recover purified and stabilized fat from the trimmings which has economic value such as for a food additive or for producing tallow.

Another method for separating animal muscle tissue from fat is disclosed in U.S. Pat. No. 7,666,456. In this method, comminuted trimmings are mixed with warm water containing carbon dioxide. This water based composition has a density which is intermediate of the density of the fat and the density of the animal muscle tissue. The fat particles are separated from the animal muscle tissue particles on the basis of differing density wherein the fat particles float on the water based composition and the animal muscle tissue particles sink to the bottom of the water based composition. During the process both the fat particles and the animal muscle tissue particles remain in the solid state. It is also disclosed that the pH of the water based composition can drop to less than 2 and that this can reduce the bacterial population that is present at the animal muscle tissue surfaces.

A further problem with recovering animal muscle protein from fatty animal tissue is that the protein can contain microorganisms such as E. coli that are unsuitable for human consumption. One method for destroying microorganisms involves the use of ammonium hydroxide, which has the problem set forth above and, thus, is undesirable.

The process disclosed in U.S. Pat. No. 6,949,265 discloses a method for reducing or eliminating surface bacteria and pathogens by pre-scalding trimmings. The muscle tissue is separated from fat tissue by heat to liquefy the fat tissue but below 110° F. so as to avoid cooking the muscle tissue while the muscle tissue remains solid. The liquid fat is then separated from the solid muscle tissue. This process may be undesirable since microorganisms grow rapidly at elevated temperatures between about 40° F. and about 140° F.

It is also desirable to process animal muscle tissue in a manner which retains color and functionality of the recovered protein product. It is desirable to obtain a lean protein product that maintains or has a red color. Also, protein functionalities of most concern to food scientists are solubility, water holding capacity, gelation, foam stability and emulsification properties.

It is also desirable to process the animal tissue in a manner which results in a final product that has large fibers, which better resembles fine ground or coarse ground beef.

It is also desirable to provide a process for producing a fat fraction having a relatively low concentration of water and which is stable against oxidation. Such a form of fat permits its addition to a variety of food products such as beef products.

The U.S. government provides that a certain quality of meat product obtained from animal trimmings can be used undeclared in meat products of the same species. For example, “finely textured beef” and “lean finely textured beef” can be used in ground beef without being declared on the label. According to the US government, “Finely textured meat” is required to have a fat content of less than 30%; a protein content of 14% or greater, by weight; a protein efficiency ratio (PER) of 2.5 or higher, or an essential amino acids (EAA) content of 33% of the total amino acids or higher; must be prepared in a federally inspected plant; must not have a product temperature during processing exceeding 110° F.; must be frozen in less than 30 minutes after processing; must not allow a significant increase in bacterial numbers; and must not be treated with chemicals or additives that remain in the meat. Also according got the US government, “Lean finely textured meat” (LFTM) is required to have a fat content of less than 10%, by weight, and complies with the other requirements of “finely textured meat”.

Accordingly, it would be desirable to provide a process for isolating animal muscle protein from fatty animal tissue containing animal muscle tissue such as trimmings wherein the process provides high yields of lean animal muscle having a red color and/or is functional. In another embodiment, it would be desirable to obtain an uncooked, lean protein composition having a red color from animal muscle tissue having greater than 50% fat. Furthermore, it would be desirable to provide a fat product from trimmings which is stable against oxidation and which has a relatively low concentration of water. Also, it would be desirable to provide an animal muscle protein product that has a similar or reduced sodium content as compared to the original meat. In addition, it would be desirable to provide such a process which eliminates undesirable smell characteristics such as the smell of ammonia. Furthermore it would desirable to produce a final beef product that has large fibers which results in a more desirable ground beef-like texture and mouth feel. Such a process would provide high recovery rates of fat stable against oxidation and of animal muscle protein in a low microorganism environment while avoiding the addition and retention of ingredients which adversely affect edibility of the protein product. In addition, it would be desirable to provide such an animal muscle tissue protein having a color which permits its satisfactory addition to high protein foods such as ground beef.

### SUMMARY OF THE INVENTION

In accordance with this invention, a process is provided for isolating both animal muscle protein having a satisfactory color and fat stabilized against oxidation from meat trimmings comprising animal muscle tissue and fat. In certain embodiments, the process provides high yields of functional animal muscle protein having satisfactory color while avoiding problems due to the presence of microorganisms and avoiding problems which render the recovered proteins inedible. The process of this invention also provides a fat product which is stable against oxidation and which contains a relatively low water concentration. The process of this invention is capable of meeting the definition of “finely textured meat” (e.g., fat content of less than 30%; a protein content of 14% or greater, by weight) or “lean finely textured meat” (e.g., fat content of less than 10%, a protein content of 14% or greater, by weight) as presently defined by the U.S. government.

The process of this invention includes the process steps of comminuting fresh or frozen meat trimmings or animal muscle tissue having an average fat content between about 50% and 85% by weight and a lean content between about 50% and about 15% by weight, adding cold potable water to the comminuted trimmings; optionally adding a food grade acid; homogenizing the trimmings-water mixture; adding a food grade acid to the homogenized trimmings to lower the pH of the resultant mixture to between 3.6 to 4.4, preferably between 3.6 and 3.8 to selectively dissolve the animal muscle tissue; separating the solid fat from the acidic solution of animal muscle protein; recovering the solid fat; optionally evaporating water from the acidic solution of animal muscle protein to form a concentrated protein solution; recovering the acidic solution of animal muscle protein or adding a food grade alkaline composition to the acidic animal muscle protein solution to increase the pH to between about 4.9 and about 6.4, preferably between about 5.2 and about 5.8 to form a salt from the reaction of the acid with the alkaline composition and to precipitate the protein, separating the solid protein from the remaining liquid such as by centrifugation and/or screen filtration and optionally freezing the resultant essentially neutral animal muscle protein composition.

It has been found that when reducing the pH of animal muscle tissue from 3.6 to 4.4 in accordance with this invention, the animal muscle tissue is solubilized while retaining essentially its original color and that satisfactory yields of muscle tissue (protein) are obtained. In order to render the solubilized animal muscle tissue useful for addition to ground animal muscle tissue such as beef hamburger, the solubilized animal muscle tissue should have a color of 75 to 52 L*, 25 to 10 a* and 23 to 16 b* wherein L*, a* and b* are defined according to the Commission Internationale de I′Eclarage (CIE) as L* (luminance or muscle lightness), a* (redness or muscle redness), b* (yellowness or muscle yellowness). For example, in the case of animal muscle tissue, the original red color is retained. In contrast, when the pH is about 3.5 or less, the tissue color becomes brown and does not revert to its original color. A protein composition having a brown color is not suitable for addition to a food having a normal red color such as hamburger. It has also been found that solubilization of the animal muscle tissue in acid results in a significant reduction of viable microorganisms, particularly when utilizing food grade hydrochloric acid as the acid. One particular food grade acid and base combination of interest in this present invention is citric acid to lower the pH and sodium bicarbonate to raise the pH. It has also been found that mixing the fat with food grade acid in accordance with this invention, stabilizes the fat against oxidation. In addition, it has been found that when mixing the fat containing acid with a food grade base to a pH between about 4.9 and about 5.8 effects separation of water from the fat from about 70 to about 50 weight % down to a water content between about 30 and about 20 weight percent. This result simplifies subsequent water removal from the fat if such additional water removal is desired. Lastly, in the process of this invention, the presence of undesirable acidic or alkaline additives in the final protein product is eliminated due to the neutralization of the acid with the alkaline.

In an embodiment, the present invention relates to a process for recovering uncooked, lean protein composition having a color of 75 to 52 L*, 32 to 15 a*, and 23 to 7 b*. The lean uncooked meat is obtained from a high fat meat, e.g., animal muscle tissue having an average fat content between about 50% and 85% by weight and a lean content between about 50% and about 15% by weight. The method involves adding water to animal muscle tissue and comminuting, homogenizing or mixing the animal muscle tissue and water to obtain an animal muscle tissue preparation. When adding water to mix, homogenize or comminute, the water is added in a ratio between about 1:0.5 animal muscle tissue to water and about 1:2 animal muscle tissue to water. The method involves solubilizing the protein of the animal muscle tissue preparation with either food grade alkali (e.g., is sodium bicarbonate, sodium carbonate, potassium bicarbonate, potassium carbonate, or sodium hydroxide) or food grade acid (e.g., citric acid, ascorbic acid, phosphoric acid and hydrochloric acid). In the case of food grade alkali, the pH is adjusted to a range of about 8.3 to about 10.5 (e.g., about 9.0, 9.3, 9.5, 9.7, 10.0, 10.3, 10.5) to obtain a solubilized protein, fat and water mixture. In the case of food grade acid, the pH is adjusted to pH in the range of about 3.6 to about 4.4 (e.g., about 3.6, 3.8, 4.0, 4.2). Once the protein is solubilized, the solubilized protein, fat and water mixture is heated to a temperature between about 84° F. and about 107° F. (e.g., about 85, 90, 95, 100, or 105° F.) such that fat in the solubilized protein becomes a liquid form, to thereby obtain a heated solution that has at least solubilized protein, liquid fat and water. The next steps can be either a precipitation step followed by a separation step, or a separation step followed by a precipitation step. The separation steps can be performed by centrifugation, filtration, decantation. In a preferred embodiment, this step is performed by centrifugation.

In an embodiment in which the next step is a precipitation step (followed by a separation step), the pH of the heated solution is adjusted to a pH in the range between about 4.8 and about 7.5 (e.g., about 5.0, 5.2, 5.4, 5.6, 5.8, 6.0, 6.2, 6.4, 6.6, 6.8, 7.0, 7.2, 7.4) to obtain a suspension having at least precipitated protein, liquid fat and water. In an embodiment, the pH is adjusted so that it is at or near the isoelectric point for the animal muscle tissue to effect precipitation. The precipitated protein is separated from the liquid fat and water (either by a two-way or three-way separation technique). In the embodiment in which there is a three-way separation, the precipitated protein, the liquid fat and the water are separated in one step. In the case in which there is an initial two-way separation, the precipitated protein is separated from a liquid phase having at least liquid fat and water, and a second two-way separation is performed wherein the liquid phase is separated into liquid fat and water.

In the embodiment in which the separation step and is followed by the precipitation step, the liquid fat is separated from a liquid phase having the solubilized protein and water, and then the liquid phase having solubilized protein and water is precipitated by adjusting the pH to a range between about 4.8 and about 7.5 (e.g., about 5.0, 5.2, 5.4, 5.6, 5.8, 6.0, 6.2, 6.4, 6.6, 6.8, 7.0, 7.2, 7.4) to obtain a suspension having at least precipitated protein and water. In an embodiment, the pH is adjusted to a pH that is at or near the isoelectric point for the animal muscle tissue to effect precipitation. The precipitated protein is then separated from the water, as described herein.

In either embodiment, the precipitated protein composition has a color of 75 to 52 L*, 32 to 15 a*, and 23 to 7 b* (e.g., 75 to 52 L*, 25 to 15 a*, and 23 to 16 b*), and the precipitated protein is an uncooked, lean protein having about 14% or greater (e.g., about 15, 16, 17, 18, 19, 20, 21, 22, 23, 24, 25%) by weight protein and less than about 30% (less than about 25%, 20%, 15%, 10%, 9%, 8%, 7%, 6%, 5%, 4%, 3%, 2%, 1%, 0%) by weight fat. In an aspect, the lean precipitated protein composition also has functionality of raw meat as measured from a measurement selected from the group consisting of: water binding test, meat emulsion test, moisture retention test and a combination thereof.

### BRIEF DESCRIPTION OF THE DRAWING

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a process flow diagram of the process of this invention.

FIG. 2 is a flow diagram showing the steps of an embodiment of the process for obtaining uncooked lean protein in which high fat animal muscle tissue is comminuted, solubilized, heated to a temperature less than 107° F. to obtain a solution of solubilized protein and liquid fat, and the protein is precipitated and then separated from liquid fat.

FIG. 3 is a flow diagram showing the steps of an embodiment of the process obtaining uncooked lean protein in which high fat animal muscle tissue is comminuted, solubilized, heated to a temperature less than 107° F. to obtain a solution of solubilized protein and liquid fat, and the liquid fat is separated from the solubilized protein, and then the protein is precipitated.

### DETAILED DESCRIPTION OF SPECIFIC EMBODIMENTS

The present invention relates to a method for processing animal trimmings to recover meat products low in fat content and high in protein and essential amino acid content as well as a stabilized fat product. “Meat product” describes a protein-containing product which is suitable for human consumption as meat because it contains a certain amount of protein. Generally, “trimmings” refers to the tissue cut away from conventional cuts or parts of the carcasses of meat producing animals during butchering operations in packing houses and the like. The conventional cuts or parts are generally sold directly to consumers or further processed by, for example, grinding into ground beef. The tissue remaining after the conventional cuts are removed, or after the conventional cuts have been further trimmed, generally has a fat content which is too high for human consumption as meat, but contains proteins which can be recovered.

According to the present invention, once the trimmings are removed from the carcasses, they are preferably forwarded directly to the process of the present invention. Alternatively, the trimmings can be frozen or cooled and stored prior to processing. The temperature of the trimmings, upon removal from the carcasses is usually about 33-40° F. which corresponds to the temperature at which the carcasses are stored prior to butchering. Warmer or cooler trimmings can be used in the process of the present invention.

The trimmings can include any part of an animal which is trimmed away from the carcass of the animal or the cuts. The trimmings can include all the parts normally found in an animal, including adipose tissue, fat, lean ligaments, tendons, bone parts, and the like. It is generally desirable that if components other than fat, lean, and moisture are present, they are present in small quantities and/or can be removed in the desinewing step or by hand, if desired, or can be left therein if their presence does not adversely affect the properties of the meat product. If large amounts of certain components are present, it may be desirable to have them removed by conventional separation techniques prior to processing according to the present invention. For example, it is generally desirable not to have large amounts of bone present or large amounts of low quality ligaments.

In an embodiment, animal muscle tissue used as a starting material for the present invention include animal muscle tissue having a high fat content and includes for example meat trimmings. Such animal muscle tissue having an average high fat content includes tissue having between about 50% and 85% by weight and a lean content between about 50% and about 15% by weight,

“Meat producing animals” includes animals which are known to provide meat. Such animals include beef, pork, poultry such as chicken, turkey, (e.g. mechanically deboned turkey), lamb, deer, buffalo, and the like. The lean material can be referred to as protein-containing material, and can be in the form of water soluble protein which include muscle fiber, and non-water soluble protein which are generally the myofibrillar or locomotion proteins or the connective tissue which surrounds muscle fiber and which attach the muscle fibers to ligaments. Of particular interest for purposes of the present invention is the presence of the water soluble protein and the acid soluble protein from the animal muscle tissue in the fatty tissue within the fat trimmings. By separating this protein material from the animal trimmings, a high quality meat product can be provided. This product can be utilized as raw meat or as an additive to conventional meat products such as to hamburger.

Animal trimmings or animal muscle tissue, which can be used as a meat source in the present invention preferably, have an average fat content of between about 50 and 85% (e.g., about 50, 55, 60, 65, 70, 75, 80, and 85% fat) by weight, preferably between about 50 and 70% by weight. The lean content of the animal trimmings is preferably between about 15% and 50% (e.g., about 15, 20, 25, 30, 35, 39, 40, 45, 50% lean content) by weight, and more preferably between about 30% and 50% by weight. The lean content includes protein and moisture. In order to ensure reliable and consistent results, in an embodiment, the lean content of the animal trimmings or animal muscle tissue is at least about 30% by weight and preferable at least about 39% by weight.

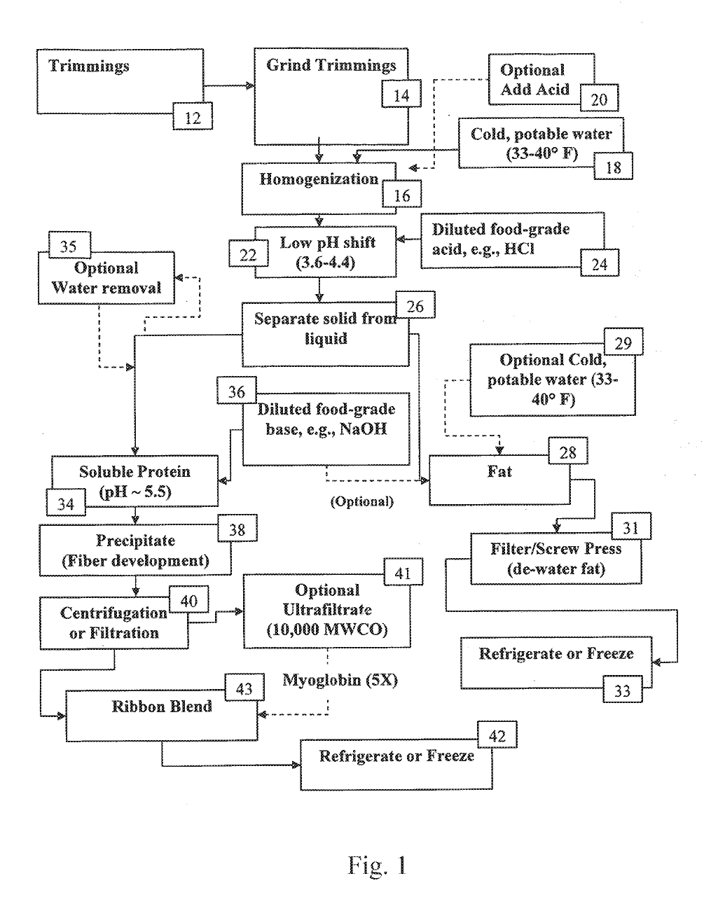

Referring to FIG. 1 which illustrates a preferred embodiment of this invention, boneless trimmings 12 such as beef trimmings containing about 50% by weight beef muscle tissue and about 50% by weight fat, mechanically separated beef or the like are directed to a comminution step 14 which increases the surface area of the beef trimmings rendering it more suitable for further processing. Advanced Recovered Meat (AMR) also can be utilized as a feed. Suitable comminution apparatus include meat grinder available from Weiler and Company corporation located in Whitewater, Wis. or Carnitec USA, Inc, located in Seattle, Wash. The starting meat trimmings are first ground to a size that enables it to be put through a micro-cutter. It is preferable to coarse cut ¾ inch, followed by a ⅛ inch grind. Once ground, the material is mixed with water (33-40° F.) at a ratio of one part ground meat to approximately 5-6 parts water. This amount of water can vary and can go as high as approximately 1 part ground meat to 10 parts cold water. The addition of water lowers the ionic strength of the homogenate which is required for complete solubilization of the proteins. Optionally, acid can be added to the trimmings in step 20 to improve protein solubilization. The comminuted trimmings are directed to homogenization step 16 where it is mixed with potable water 18 at a water temperature typically between about 33° F. and about 40° F. and homogenized, typically to an average particle size of about 0.5 to about 4 millimeters preferably between about 1 to about 2 millimeters. In this embodiment, a preference has been shown for a micro-cut with a 0.035 mm cutting head size. Representative suitable homogenizers for this purpose include emulsifiers or micro-cutters, available from Stephan Machinery Corporation, located in Columbus, Ohio or high-shear mixers available from Silverson, located in East Longmeadow, Mass. or the like.

In a step to control microorganisms, in an embodiment, the temperature of the homogenate is kept cold throughout the process (33-40° F.). The cold temperature is most effective for separating the fat from the protein. This unit operation is accomplished while the pH is still near the pH of the initial muscle. An alternative is to add enough food-grade acid to bring the composite pH to the isoelectric point. Typically, the isoelectric point is about pH 5.5, but it can vary from species to species. At the isoelectric point, proteins are least able to form emulsions with lipid molecules, and therefore, more lipid renders away from the proteins during the extraction process. Once the tissue is homogenized, it is ready to be adjusted to a low pH.

The resultant homogenate is directed to step 22 wherein it is mixed with a food grade acid 24 such as dilute hydrochloric acid, dilute phosphoric acid, dilute citric acid, ascorbic acid, tartaric acid or mixtures thereof or the like in order to reduce the pH of the homogenate to between pH 3.6 and pH 4.4, preferably between pH 3.6 and pH 3.8 to dissolve animal muscle tissue thereby to obtain a satisfactory yield of protein such as 80% yield or higher in an acidic protein solution thereof while retaining the fat portion in solid form. It is preferred to utilize hydrochloric acid since its use results in more significant reduction of viable microorganisms in the acidic protein solution.

Acidification of the proteins under low salt conditions has been shown to unfold the proteins, which is believed to create more surface area along the proteins and hence more potential water binding sites. Once the proteins are soluble, the fat renders away from the proteins and floats to the surface of an aqueous acidic solution. Other potential impurities, including any residual bone, skin or sinew, stay insoluble as well. The pH is adjusted to 3.6 to 4.4 to obtain the desired color of the final product. As an example, the approximate amount of acid needed to effect solubilization of the muscle proteins is approximately 0.15 to 0.80 weight %, e.g. 0.198 weight % based on the weight of HCl to total weight (pH 3.74). This amount is dependent on the desired low pH (pH 3.6 or 4.4) and also on the pH of the starting material. Suitable mixers to effect this step include Lighting Mixers available from SPX corporation, located in Charlotte, N.C. or the like.

The resultant mixture of acidic solution of animal muscle protein and solid fat then is directed to separation step 26 such as a decanter centrifuge and/or screen filter 26 to separate the acidic protein solution from the solid fat.

Subsequent to the solubilization of the proteins and removal of impurities and fat, the proteins are subjected to an increase in pH such as by the addition of diluted, food-grade base such as sodium hydroxide (NaOH) or sodium bicarbonate (NaHCO3). The base is added until the isoelectric point is obtained and the proteins refold and rejoin with each other to form large, fiberized molecules. Upon reaching the isoelectric point pH, the proteins easily release their closely aligned water molecules, and the moisture content can be returned to the moisture content found in meat or consistent with LFTM. The solid fat in step 28 is optionally mixed with a food grade alkali to separate water from fat and to neutralize the fat. Optionally, cold potable water from step 29 can be added to the fat in step 28. The alkali promotes separation of fat from water. The fat then is filtered in step 31 to remove water from fat and reduce the water content from about 70 to 50 weight percent to about 30 to 20 weight percent. Optionally, the fat can be refrigerated or frozen in step 33. Suitable filtration apparatus include vibrating screen available from Sweco Corporation, located in Florence, Ky. or the like. The screens have a size between about 4000 micron and about 2000 microns, preferably between about 3500 microns and about 2500 microns. Additional base can be added in step 34 to bring the pH of the precipitated proteins back to the original pH of the tissue. This assures that the base (NaOH or NaHCO3) has fully reacted with and consumed all of the previously added acid such as HCL or citric. An optional step is to direct the protein product to a unit operation 35 which removes water to concentrate the liquid for the purpose of creating larger fibers upon raising the pH. The unit operation could consist of any device found to remove water in a continuous or batch manner, such as an evaporator or more desirable an ultrafiltration unit. The amount of water removed can vary, however, greater amounts of water removed results in larger and more robust and sturdy fibers and increased protein recovery. The resultant protein product is a viscous sediment containing protein at a concentration of about 4-14 percent by weight or higher to produce a protein containing solution which is directed to mixing step 34 wherein it is mixed with food grade alkaline 36 such as sodium hydroxide, potassium hydroxide, sodium bicarbonate or the like. The protein product is precipitated in step 38 and is recovered such as by centrifugation and filtration in step 40. Optionally, an ultrafiltrate retentate having a >5000-10000 molecular weight cut off (MWCO) is recovered in step 41. This ultrafiltrate has an elevated concentration of myoglobin having a red color and can be blended as desired with the precipitated protein in step 43. This results in a protein product having an improved red color and reduced sodium content. The sodium is concentrated in the lower molecular weight fraction that is discarded. The resultant product has improved red color, desired reduced sodium and is obtained by a process (pH 3.6-4.4) that provides high yield of protein from the trimmings of about 80% or greater. Thus, the process of this invention, provides a greatly improved protein product over the available prior art.

The protein product from step 40 contains 14 percent or greater by weight protein, contains less than 10 percent by weight fat, is produced at a temperature less than 110° F., can be frozen within 30 minutes in step 42 from process completion, does not allow a significant increase in bacteria and, in the embodiment wherein the protein precipitated with alkali does not retain chemicals or additives other than a low concentration of salt such as sodium chloride or the like.

The meat protein products of this invention are not significantly altered by the processing method of this invention. An examination of the proteins associated with the starting meat source and the lean cold processed meats (precipitated refolded protein) shows that the extraction process is mild enough not to effect changes in the proteins throughout the entire process. It also shows that very little to no hydrolysis has occurred during the processing, partly due to the low temperature. Refolding of the protein also does not affect its profile.

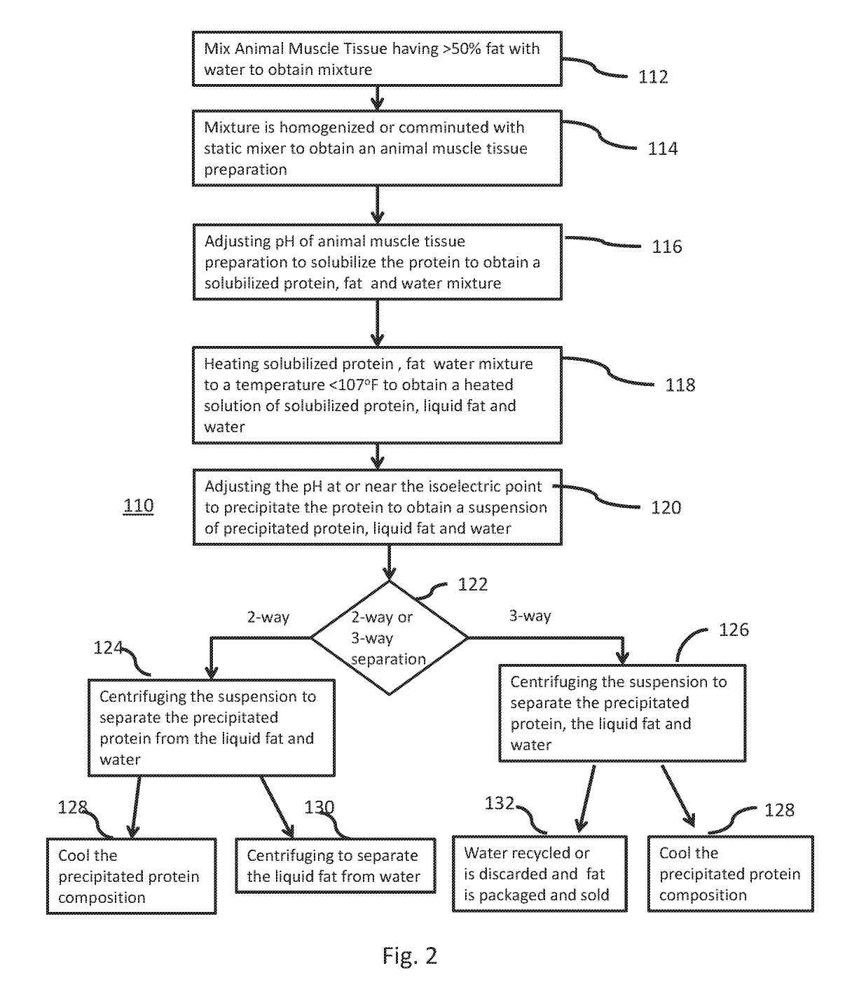

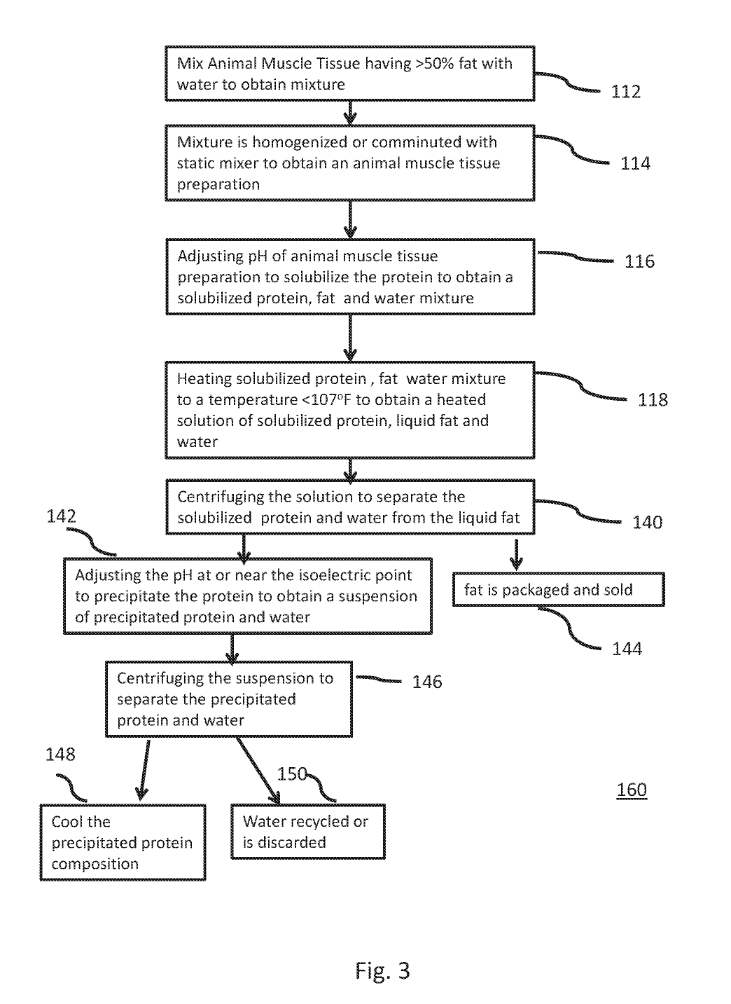

In summary, the process of this invention produces protein in higher yields as compared to the prior art, contains fewer microorganisms as compared to the prior art and is in a form by which it can be more easily mixed with meat as compared to the products of the prior art. In addition, the fat product obtained is stabilized against oxidation. Referring to FIG. 2, method 110, described herein, results in uncooked, lean animal muscle tissue protein that has a red color, namely a color of 75 to 52 L*, 32 to 15 a*, and 23 to 7 b* (e.g., 75 to 52 L*, 25 to 15 a*, and 23 to 16 b*). The uncooked, lean protein is obtained from a high fat animal muscle tissue after undergoing the methods described herein, and shown in FIGS. 2 and 3. The process of the present invention enables animal muscle tissue with high fat content, which would be otherwise difficult to use, to serve as a source of uncooked, lean meat. The starting material is animal muscle tissue with a high fat content includes that which has an average fat content of between about 50 and 85% by weight, preferably between about 50 and 70% by weight, and lean content of between about 15% and 50% by weight, and preferably between about 30% and 50% by weight. The resulting uncooked, lean protein product having 14% or greater (e.g., about 14% to about 25%, or about 15, 16, 17, 18, 19, 20, 21, 22, 23, 24 and 25%,) by weight protein and less than 30% (about 1% to about 30%, or about 30, 25, 20, 15, 10, 9, 8, 7, 6, 5, 4, 3, 2, 1, and 0%) by weight fat. The process of the present invention allows one to take a high fat content protein, which would be difficult to use or sell, and transforms the protein into an uncooked, lean protein product with a red color that can be consumed or added to meat for consumption. In addition to the protein product having a red color, the uncooked, lean animal muscle tissue protein can also have characteristics of raw meat (e.g., functional meat).

As shown in the FIG. 2, lean protein process 110 uses step 112 to mix water with the animal muscle (meat) having a high fat content or meat trimmings. The types of meat and the fat content have been described herein. Step 112 involves mixing high fat animal muscle tissue with water in a ratio of parts of meat to water ranging from about 1:0.5 animal muscle tissue to water to about 1:2 animal muscle tissue to water. In an aspect, the temperature of the water ranges from just above the freezing point to a point below room temperature. For example, the temperature of the water ranges from about 34° F. to about 70° F., and in an embodiment is between 37° F. and about 40° F. Step 112 results in a mixture of water and meat. Alternatively, Step 112 can use cool tap water, or can be optional.

In step 114, this animal muscle tissue/water mixture is then comminuted using a static mixer. The mixture can be comminuted, homogenized and/or mixed. Comminuting refers to a process in which the animal muscle tissue is cut into smaller pieces to increase the surface area of the available protein. Homogenizing or mixing refers to a process in which the particles in a mixture become uniform or evenly distributed. In step 114, a static mixer comminutes the animal muscle tissue to increase the surface area of the protein, and the resulting compositions is referred to herein as an animal muscle tissue preparation. Comminution or homogenization can occur using any commercially available apparatus such as a food chopper or cutting/dispersion machine. Examples of such machines that can be used homogenize the chilled mixture include STEPHAN MICROCUT cutting and dispersing systems (Hamelin, Germany), KARL SCHNELL mixers (New London, Wis.), WARING Model WSB immersion blenders, or static mixer (Koflo, Cary, Ill.) The length of time needed to achieve a comminution or a uniform homogenate depends on the volume of the mixture, the type of motor on the apparatus, and capacity of the machine being used. In an embodiment, comminution, mixture or homogenization can be performed in a time ranging between about 30 seconds and about 15 minutes (e.g., between 40 seconds and about 2 minutes). In an aspect, the addition of water to the high fat animal muscle tissue, and comminuting/mixing/homogenizing can happen simultaneously or there can be overlap between the steps (e.g., a portion of the water can be added gradually after chopper/mixer is in use). During the step 114, it is believed that the available surface area of the protein is increased so that it can better, more effectively solubilize in the next step, step 116.

In step 116, the animal muscle tissue preparation from step 114 is solubilized. Solubility can occur with the addition of a food grade acid or base. As used herein, “solubilized protein” refers to the protein being dissolved in liquid or put into solution. In an embodiment, acid or base is added in a sufficient amount and concentration to allow the protein to dissolve or solubilize. Any food grade acid or base can be used to adjust the pH to ranges described herein to solubilize the protein. Examples of such bases include sodium bicarbonate, sodium carbonate, potassium bicarbonate, potassium carbonate, or sodium hydroxide. In an embodiment, sodium carbonate can be used in a concentration between about 0.7% and about 10% solution, and sodium bicarbonate can be used in a concentration between about 0.5% to about 10% solution (e.g., between about 5 and 6%). The volume and concentration of base used to solubilize the protein at the desired pH will depend on the starting pH of the solution, and the volume of the solution being brought to the proper pH. Similarly, examples of food grade acids that can be used for the present invention include citric acid, phosphoric acid, ascorbic acid or hydrochloric acid. Other acids or bases, previously known or later developed, can be used in the steps of the present invention so long as they solubilize (or precipitate, as the case may be) the protein under conditions described herein and are biocompatible or food grade. The concentration of the food grade acid or base will depend on the particular acid being used and the composition (e.g., liquid or powder acid forms) but ranges between about 0.5M to about 3M (e.g., between about 1M and about 2 M) (molarity) or between 0.2% to about 90% w/w % (approximate strength). For example, in the case of citric acid, a concentration of about 2M (e.g., between about 0.5M and about 3M) and in the case of hydrochloric acid, a concentration of 1M (e.g., between 0.2 and about 2M) can be used to solubilize the protein. With respect to phosphoric acid, an 85% strength can be used. In the case of citric acid and phosphoric, about 0.3% and about 1% by weight can be used, and for hydrochloric acid, a range of about 0.2 to about 0.5% by weight can be used with the steps of the present invention. When using ascorbic acid with the methods of the present invention, its powder/crystalline form can be used in which case the ascorbic acid power can be added directly to the animal tissue preparation. The choice of the food grade acid and its concentration should be one that does not denature the protein in the animal tissue preparation. For example, when using sodium bicarbonate it can be used as a powder added directly to the liquid protein or as a 10% solution with water. In an embodiment, the base adjusts the pH of the comminuted/mixed animal muscle tissue to obtain a resulting pH in the range of equal to or between about 8.3 and about 10.5 (e.g., about 8.4, 8.5, 8.6, 8.7, 8.9, 9.0, 9.1, 9.2, 9.3, 9.4, 9.5, 9.6, 9.7, 9.8, 9.9, 10.0, 10.1, 10.2, 10.3, 10.4). When using acid, the acid adjusts the pH of the animal muscle tissue preparation to obtain a resulting pH in the range of equal to or between about 3.6 and about 4.4 (e.g., about 3.7, 3.8, 3.9, 4.0, 4.1, 4.2, 4.3). Upon obtaining a pH in this range and solubilizing the protein, one obtains a mixture of solubilized protein, fat and water and can proceed to the next step, Step 118.

Step 118 heats the solubilized protein, fat and water mixture to an internal temperature of not more than 107° F. (e.g., a range from about 84° F. to about 107° F.). This step can be performed at temperatures of about 84, 85, 86, 87, 88, 89, 90, 91, 92, 93, 94, 95, 96, 97, 98, 99, 100, 101, 102, 103, 104, 105, 106, and 107° F., or a combination thereof. Meat is not considered to be cooked when subjected to temperatures of 107° F. or less. A heating temperature of 107° F. or less does not allow for the animal muscle tissue to be cooked but it does allow the fat in a solid form to transition to a liquid form (e.g., transform from a solid state to a liquid state). The solubilized animal muscle tissue having a high amount of fat, and subjected to heat in this temperature range, will transition the fat to its liquid state over a time range between about 1 second to about 10 minutes (e.g., about 2-4 minutes). The transition the solid fat into liquid fat is a function, in part, of time, volume, temperature, and the surface area of the heating element. For example, fat of solubilized animal muscle tissue subjected to a temperature of 105° F. will convert to liquid form at a faster rate than fat subjected to 95° F. In an embodiment, fat of solubilized animal muscle tissue subjected to a temperature of 105° F. converted to its liquid state in about 4 minutes. Heaters, heat exchangers, or ovens can be used to apply heat in step 118. Examples of such heaters include falling film heat exchangers and tubular heat exchangers or swept surface heat exchangers. Heat exchangers are able to deliver heat as well as cool the meat and if used in present invention, can be used in both step 118 and later step 128. In an embodiment in which a heat exchanger is not used, a heater/oven or other device can be used to irradiate heat to accomplish step 118. An example of a heater is Commercial Cooking Appliance Model KR-S2 hot plate or ConTherm, Alfa Laval, Newburyport, Mass. This step produces a heated solution having solubilized protein, liquid fat and water.

In FIG. 2, the heated solution having a solubilized protein, liquid fat and water undergoes step 120 in which the protein is precipitated to form a suspension of precipitated protein, liquid fat and water. In an embodiment, precipitation occurs at step 120 by adjusting the pH of the heated solution at or near the isoelectric range of the meat involved. The isoelectric range for meat, in general, is a pH between about 4.8 and about 7.5 (e.g., a pH of about 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4). The isoelectric range can depend, for instance, on conditions such as salt, the type of protein, the charge of the protein, the amino acids that make up the protein, and the ionic strength of the solution to which the protein has been subjected. Adjusting the pH to the aforementioned isoelectric range can be performed by adding either an acidic solution or a basic solution to the heated solution. If an acid was added in step 116 solubilize the protein, then base can be added in this step 120 to precipitate the protein. Similarly, if base was added in step 116 to solubilize the protein, then acid can be added in this step 120 to precipitate the protein. Any food grade acid or base can be used to adjust the pH to these ranges and examples and amounts of such acids and bases are provided herein (e.g., in the discussion of step 116). Step 120 results in a suspension having a protein precipitate, liquid fat and water (hereinafter referred to as “protein precipitate suspension”).

Another way to precipitate the protein from the heated solution (at acid or alkaline pH values) is to add salt. Examples of salts that can be used to precipitate the protein from solution include sodium chloride (NaCl) and potassium chloride KCl). The concentration of NaCl or KCl ranges between about 3.5% and about 8% by weight.

The protein precipitate suspension of step 120 is processed to separate the protein, the liquid fat and water in at decision box 122. A two-way separation, step 124, or three-way separation, step 126, can be performed. Separation can be performed using a centrifuge, a decanter, or by filtration. In an embodiment, lipid separation can be performed by using centrifugation. If performed, centrifugation occurs, in an aspect, in a range between about 3200 RPMs and about 5000 RPMs for between about 1 minute and about 10 minutes (e.g., between about 2 and about 5 minutes) or during a continuous operation in which the heated solution is continuously flowing throughout the system including the centrifugation. During centrifugation, protein precipitate mixture is separated by either a two-way and three-way separation. In the case of a three-way separation, the precipitated protein, liquid fat and water are separated in one step. In this case, the precipitated protein can be cooled or frozen in step 128 using a heat exchanger or freezer, and the liquid fat can be further processed, packaged and sold and the water recycled or discarded in step 132. In the case of a two-way separation, the liquid fat and water (the liquid phase) is separated from the precipitated protein phase in step 124. Centrifuging the liquid phase a second time (e.g., a second two-way separation) in step 130, the liquid fat is separated from the water. Centrifuges that can be used for Step 124, 130, 126, include disc centrifuges from Alfa Laval (Lund, Sweden), GEA/Westfalia, (Oelde, Germany).

After steps 124 or 126, the precipitated protein step 128 chills or freezes the precipitated protein. In an embodiment, the temperature of the precipitated protein is the freezing point or below. In an embodiment, the temperature at step 128 is lowered to a range equal to or between about 34° F. and about 45° F. (equal to or between about 1° C. and about 7° C.). In an aspect, the time to lower the precipitated protein will vary depending on apparatus used, the volume and density of the protein. Once the temperature of the precipitate protein is uniformly lowered to the desired range, a chilled, precipitated protein is obtained and ready to be used as raw meat or for application to raw meat.

Referring to FIG. 3, process 160 is similar to that described in FIG. 2, except that a separation step occurs before the precipitation step. Once the heated solution of solubilized protein, liquid fat and water is obtained in Step 118, separation step 140 can occur. The separation step involves separating the liquid fat from the solubilized protein and water. The liquid fat of step 144 can be processed, packaged and sold, and the solubilized protein/water solution undergoes precipitation step 142 and precipitation procedures have been described herein. Briefly, the protein is precipitated by adjusting the pH to a range between about 4.8 and about 7.5, or at or near the isoelectric point. As described herein, food grade acid or base can be added to effect the protein precipitation. Precipitation step 142 results in a suspension of precipitated protein and water, which are then separated by centrifuge to separate the water from the protein precipitate in step 146. Water that can be recycled in step 150 and the protein precipitated is cooled or frozen in step 148, as described herein.

Devices for heating and/or chilling are known in the art and commercially available. Step 118, the heating step, can be carried out by any device that can deliver the amount of heat needed to achieve conditions for heating fat to change its phase from solid to liquid, as described herein. Examples of such devices include heat exchangers, including falling film heat exchangers and tubular heat exchangers. Heat exchangers are able to deliver heat as well as cool the meat and if used in present invention, can be used in both steps 118, 128 and 148. In an embodiment in which a heat exchanger is not used, a heater/oven or other device can be used to irradiate heat to accomplish step 118, and a refrigerator, freezer or other similar device can be used to cool or freeze the protein product. An example of a heater is Commercial Cooking Appliance Model KR-S2 hot plate.

The next steps performed depend on the end product desired. The end meat product can be a ground (e.g., hamburger/sausage/hotdog) type end product, a protein marinade, or a protein powder. Depending on the end product, water can be added or removed. For products, such as a marinade, water may be retained or added. In cases in which water is not desired, such as for ground beef applications, water is removed from the protein precipitate mixture by using a strainer, decanting centrifuge or filtration. The amount of water removed can vary, again based on the desired end product. In one embodiment, the moisture content of the protein precipitate mixture after dewatering/centrifuging can range from between about 60% and 99%. The resulting protein is one that is of a hamburger/sausage stuffing texture. If a protein powder is desired, one can decide to spray dry the dewatered precipitate. Spray drying can be performed by commercially available apparatus, such as a 30-inch Bowen Spray Drying unit, machine or a GEA Niro Food Spray Dryer (Søborg, Denmark). Pre-treatment steps may be taken to prevent denaturing of the protein during the spray drying process, and include, for example, adding sodium bicarbonate to the dewatered precipitate to a pH equal to or between about 6.5 to about 8.0.

In the case in which a marinade is desired, the steps include performing vacuum tumbling, Vacuum tumbling pulls moisture into the mixture uniformly. Vacuum tumbling may last for between about 20 minutes to about 90 minutes. A vacuum tumbler, such as a BIRO Manufacturing Model VTS-500 Vacuum Tumbler. In an embodiment, this step tumbles the protein precipitate mixture The vacuum tumbling step is optional, especially if the desired end product is not a marinade. The resulting protein is a protein marinade.

The resulting lean, uncooked precipitated protein having 14% or greater by weight protein and less than 30% by weight fat, as described herein, is red in color. Color is measured using the CIE L*a*b* color system in with dimension L for lightness and a* and b* for the color-opponent dimensions, based on XYZ coordinates. The L*a*b* color space includes all perceivable colors. In practice, the color is mapped using a three-dimensional integer for color representation. The lightness, L*, represents the darkest black and the brightest white, while the a* axis opponent colors red and green while the b* axis represents yellow and blue. Color can be measured using a color meter (e.g., CR-10 Plus from Konica Minolta (Ramsey, N.J., USA). The steps of the present invention surprisingly result in a lean meat that is red in color. The red color of the precipitated protein composition, is defined, in one aspect 75 to 52 L*, 32 to 15 a*, and 23 to 7 b* and in another aspect as 75 to 52 L*, 25 to 15 a*, and 23 to 16 b*.

Additionally, the lean, uncooked precipitated protein product can also like and has characteristics of raw meat. A functional meat composition is one that acts like raw, uncooked meat. Functional meat is defined as a meat composition that acts like raw meat with respect to one or more of the following characteristics: water binding, meat emulsion and/or moisture retention. The present invention includes meat compositions that meet or exceed one or more of these functional meat characteristics.

Water binding ability refers to the ability of the meat to retain and/or uptake moisture and can be tested using the procedure of Hand et. al. “A Technique to Measure the Water Uptake Properties of Meat,” 77^{th} Annual Meeting of the American Society of Animal Science, Paper No. 202 (1985). Briefly, water binding ability can be determined by adding added water to meat, shaking it, and centrifuging it. After centrifugation, the centrifuged meat is placed on a mesh wire screen and then weighed. Meat products that undergo the steps of the present invention have a water binding ability that is the same or greater, as compared to meat that does not undergo the steps of the present invention. In an embodiment, meat products that undergo the steps of the invention have a water binding ability that is about 1% to about 125% greater (e.g., between about 40% and about 60% greater), as compared to meat that does not undergo the steps of the invention.

Meat emulsion, sometimes referred to as fat emulsion, refers generally to the ability for the meat to bind or adhere to itself (e.g., its ability to stick together) and/or to form a protein matrix (e.g., a viscous meat batter). In an instance, the phrase “meat emulsion” refers to the binding ability of protein, fat, water and optionally other types of ingredients normally added to such a mix (e.g., butter, mayonnaise, seasonings, and the like). One can determine if a meat emulsion is formed by observation. It can also be measured in terms of its capacity (e.g., the maximum amount of fat or oil stabilized by a given amount of protein) or stability (the amount of fat or oil retained or separated after stressing with heat the formed emulsion/batter).

Moisture retention refers to amount/content of moisture retained in the meat product at any given time. Moisture retention in a meat product can be determined by using moisture analyzers (e.g., Ohaus MB Model 25) or by observation (e.g., observing the amount of moisture that drips or escapes the meat). Meat products that undergo the steps of the present invention have moisture retention that is also the same or greater, as compared to meat that does not undergo the steps of the present invention. In an aspect, meat products that undergo the steps of the invention have moisture that is about the same or about 1% to about 5% greater (e.g., between about 2% and about 3% greater), as compared to meat that does not undergo the steps of the invention.

The animal muscle tissue which undergoes the steps of the present invention include, for example, meat and certain poultry. Representative suitable meats include ham, beef, lamb, pork, venison, veal, buffalo or the like; poultry such as turkey, duck, a game bird or goose or the like either in fillet form or in ground form such as hamburger. In addition, meat products that can be made using the steps of the present invention include animal muscle tissue such as a sausage composition, a hot dog composition or an emulsified product. Sausage and hot dog compositions include ground meat or poultry, herbs such as sage, spices, sugar, pepper, salt and fillers such as dairy products as is well known in the art.

The following examples illustrate this invention and are not intended to limit the same.

### Example I

A test was performed to examine the degree of hydrolysis comparing the amount of non-protein nitrogen compared to the amount of protein nitrogen. Results are shown in Table 1 for Lean Cold Processed Pork & Beef made using hydrochloric acid and sodium hydroxide, and unprocessed, raw pork and beef muscle by the process of FIG. 1.

TABLE 1

| | Non Protein | Protein | |
|---|---|---|---|
| | Nitrogen | Nitrogen | Ratio |
| Sample # | (NPN) (%) | (PN) | NPN/PN |
| Raw Beef | 0.26 | 2.47 | 0.11 |
| Lean Cold | <0.02 | 1.48 | <0.01 |
| Processed Beef | | | |
| Raw Pork | 0.47 | 3.20 | 0.15 |
| Lean Cold | 0.05 | 1.62 | 0.03 |
| Processed Pork | | | |

When the ratio of NPN/PN was measured, an average of 0.03 for Lean Cold Processed Pork and an average of 0.15 for raw pork muscle were obtained. The averages for Lean Cold Processed Beef and beef muscle were <0.01 and 0.11, respectively. The higher the percentage of NPN, the greater the amount of hydrolysis has taken place. US Food and Drug (FDA) has set a standard of >0.62 for “highly hydrolyzed” proteins. Values for the Lean Cold Processed Meat proteins indicate very little hydrolysis has occurred, especially since the value is only approximately 20% for pork and <9% for beef of the value found for comparable whole raw meats, which appears to have not undergone much significant hydrolysis.

Finally, the amino acid content is similar between the starting beef and pork muscle and the lean cold processed meat from the same muscle. As shown below in Tables 2 and 3, the amino acid percentages found for both pork or beef show very little differences between the starting muscle and the lean cold processed meat. There were 45.44% essential amino acids in pork muscle and 44.97% in the lean cold processed pork. The beef values were similar with 42.81% essential percentage for the starting beef and 44.90% for the lean cold processed beef.

TABLE 2
Amino acid profile of pork muscle and lean cold
processed pork (protein extracted from the same
pork muscle using low pH solubilization, processed
according to U.S. Pat. No. 6,005,073).

| | | Low pH solubilized |
|---|---|---|
| | Protein from Pork | protein from same Pork |
| Amino acid | (% of total protein) | (% of total protein) |
| Aspartic acid | 10.92 | 11.48 |
| Threonine* | 4.53 | 4.59 |
| Serine | 5.17 | 5.22 |
| Glutamic Acid | 17.26 | 17.68 |
| Glycine | 4.85 | 4.17 |
| Alanine | 5.97 | 5.84 |
| Valine* | 4.64 | 4.96 |
| Methionine* | 3.36 | 3.55 |
| Isoleucine* | 4.42 | 4.43 |
| Leucine* | 8.79 | 8.87 |
| Tyrosine | 3.57 | 3.91 |
| Phenylalanine* | 4.90 | 5.16 |
| Lysine* | 10.55 | 10.33 |
| Histidine* | 4.26 | 3.08 |
| Argine | 6.82 | 6.73 |
| Essential amino | 45.44 | 44.97 |
| acids (%) | | |

TABLE 3
Amino acid profile of beef muscle and lean cold processed beef
(protein extracted from the same beef muscle using low pH solubilization,
processed according to U.S. Pat. No. 6,005,073

| | | Low pH solubilized |
|---|---|---|
| | Protein from Beef | protein from same Beef |
| | (% of total protein) | (% of total protein) |
| Aspartic acid | 10.65 | 10.99 |
| Threonine* | 4.39 | 4.54 |
| Serine | 5.59 | 5.57 |
| Glutamic Acid | 16.25 | 17.44 |
| Glycine | 7.72 | 4.54 |
| Alanine | 6.72 | 5.97 |
| Valine* | 4.46 | 4.46 |
| Methionine* | 2.86 | 3.11 |
| Isoleucine* | 3.79 | 4.14 |
| Leucine* | 8.39 | 9.00 |
| Tyrosine | 3.20 | 3.50 |
| Phenylalanine* | 4.73 | 4.78 |
| Lysine* | 10.79 | 11.70 |
| Histidine* | 3.40 | 3.18 |
| Argine | 7.06 | 7.09 |
| Essential amino | 42.81 | 44.90 |
| acids (%) | | |

Essential amino acids are designated*

Thus, analytical data of the amino acids and proteins demonstrate that the lean cold processed meat retains the nutritional value, protein profile, and character of meat.

### Example 2

From the perspective of microbial reduction, the process for manufacturing refolded protein of this invention has an advantage to the process for lean finely textured meat because in the process of this invention, is processed under cold conditions and the proteins will not solubilize, hence the process will not work without a certain amount of food-grade acid, which inhibits microbes. In other words, in order to obtain specified yields for the product, certain benchmarks in pH, and these pH levels are what inhibits microbes are reached. Thus, there are inherent controls in the processing of the products of this invention that enhance product safety. Analytic tests demonstrate the process effectively produces a 1-3 log reduction of the microbes as compared to the starting meat.

TABLE 4
Microbiological Results for Pork

| | Starting | Precipitated | Starting | Precipitated | Starting | Precipitated |
|---|---|---|---|---|---|---|
| | Pork | Pork | Pork | Pork | Pork | Pork |
| Analyte | #1 | #1 | #2 | #2 | #3 | #3 |
| Aerobic Plate | >250000/g | 2900/g | 200000/g | 4200/g | 120000/g | 2800/g |
| Count | | | | | | |
| Coliform (MPN) | <3/g | <3/g | <3/g | <3/g | <3/g | <3/g |
| E. Coli 0157:H7 | Neg./25 g | Neg./25 g | Neg./25 g | Neg./25 g | Neg./25 g | Neg./25 g |
| Listeria mono. | Neg./25 g | Neg./25 g | Neg./25 g | Neg./25 g | Neg./25 g | Neg./25 g |
| Staphylococci | <10/g | <10/g | <10/g | <10/g | <10/g | <10/g |
| Yeast | 40/g | 20/g | 110/g | <10/g | 690/g | <10/g |
| Mold | 30/g | 10/g | <10/g | <10/g | <10/g | <10/g |
| | Starting | Precipitating | Starting | Precipitating | Starting | Precipitating |
| | Pork | Pork | Pork | Pork | Pork | Pork |
| Analyte | #4 | #4 | #5 | #5 | #6 | #6 |
| Aerobic Plate | 64000/g | 50/g | >250000/g | 240/g | >250000/g | 250/g |
| Count | | | | | | |
| Coliform (MPN) | <3/g | <3/g | 15/g | 3.6/g | 7.2/g | 3.6/g |
| E. Coli 0157:H7 | Neg./25 g | Neg./25 g | Neg./25 g | Neg./25 g | Neg./25 g | Neg./25 g |
| Listeria mono. | Neg./25 g | Neg./25 g | Neg./25 g | Neg./25 g | Pos./25 g | Neg./25 g |
| Staphylococci | 25/g | <10/g | <10/g | <10/g | <10/g | <10/g |
| Yeast | 570/g | <10/g | 90/g | <10/g | 290/g | <10/g |
| Mold | <10/g | <10/g | <10/g | <10/g | <10/g | <10/g |

TABLE 5
Microbiological Results for Beef

| | Starting | Precipitated | Starting | Precipitated | Starting | Precipitated |
|---|---|---|---|---|---|---|
| | Beef | Beef | Beef | Beef | Beef | Beef |
| Analyte | #1 | #1 | #2 | #2 | #3 | #3 |
| Aerobic Plate | 48000/g | 8100/g | >250000/g | 4300/g | >250000/g | 6900/g |
| Count | | | | | | |
| Coliform (MPN) | 15/g | <3/g | NA | NA | NA | NA |
| E. Coli 0157:H7 | Neg./25 g | Neg./25 g | Neg./25 g | Neg./25 g | Neg./25 g | Neg./25 g |
| Listeria mono. | Neg./25 g | Neg./25 g | Neg./25 g | Neg./25 g | Neg./25 g | Neg./25 g |
| Staphylococci | <10/g | <10/g | <10/g | 18/g | <10/g | <10/g |
| Yeast | <10/g | <10/g | 50/g | <10/g | 10/g | <10/g |
| Mold | 10/g | 30/g | <10/g | <10/g | <10/g | <10/g |
| | Starting | Precipitating | Starting | Precipitating | Starting | Precipitating |
| | Beef | Beef | Beef | Beef | Beef | Beef |
| Analyte | #4 | #4 | #5 | #5 | #6 | #6 |
| Aerobic Plate | 46000/g | 3800/g | 37000/g | 430/g | 33000/g | 2800/g |
| Count | | | | | | |
| Coliform (MPN) | 3.6/g | <3/g | <3/g | <3/g | <3/g | <3/g |
| E. Coli 0157:H7 | Neg./25 g | Neg./25 g | Neg./25 g | Neg./25 g | Neg./25 g | Neg./25 g |
| Listeria mono. | Neg./25 g | Neg./25 g | Neg./25 g | Neg./25 g | Neg./25 g | Neg./25 g |
| Staphylococci | <10/g | <10/g | <10/g | <10/g | <10/g | <10/g |
| Yeast | 80/g | 240/g | 20/g | <10/g | 90/g | <10/g |
| Mold | <10/g | <10/g | <10/g | <10/g | <10/g | 10/g |

### Example 3

This example illustrates that recovery of protein from meat trimmings must be effected at a pH of 3.6 or above in order to recover a protein product from satisfactory color. This example also illustrates that initially obtaining protein having an unsatisfactory color cannot be reversibly converted to a protein product having a satisfactory color.

The results obtained in Table 6 were obtained with 40 g samples of ground beef. To each sample was added 160 ml of cold tap water (40° F.). The samples were then homogenized to a particle size of about 100 microns. The pH of each sample was adjusted with 1M food grade hydrochloric acid to a pH set forth in Table 6. Each sample was centrifuged for 8 minutes at 5000 g at 4° C. and then filtered through glass wool to separate solid fat from protein liquid composition. 40 ml of each liquid portion was poured into a container on top of white paper. Each sample was then measured twice with each sample with a Minolta colorimeter that measures L*, a* and b* values as set forth above.

The average L*, a* and b* were then computed as shown in Table 6.

TABLE 6
Color Measurements - Ground Beef

| | L* | | | L* | | | L* | a* | |
|---|---|---|---|---|---|---|---|---|---|
| pH | (1) | a* (1) | b* (1) | (2) | a* (2) | b* (2) | (AVG) | (AVG) | b* (AVG) |
| 5.8a | 75.33 | 14.63 | 15.53 | 61.95 | 30.29 | 21.55 | 68.64 | 22.46 | 18.54 |
| 5.8b | 71.40 | 18.35 | 16.59 | 76.92 | 13.93 | 15.31 | 74.16 | 16.14 | 15.95 |
| 5.8 (AVG) | | | | | | | 71.40 | 19.30 | 17.25 |
| 3.8a | 56.92 | 25.11 | 21.01 | 58.77 | 23.53 | 20.80 | 57.85 | 24.32 | 20.91 |
| 3.8b | 55.57 | 26.40 | 21.19 | 59.18 | 23.58 | 20.89 | 57.38 | 24.99 | 21.04 |
| 3.8 (AVG) | | | | | | | 5761 | 24.66 | 20.97 |
| 3.6a | 56.01 | 20.38 | 20.46 | 57.35 | 19.46 | 20.54 | 56.68 | 19.92 | 20.50 |
| 3.6b | 57.72 | 21.47 | 20.92 | 58.63 | 20.90 | 20.81 | 58.18 | 21.19 | 20.87 |
| 3.6 (AVG) | | | | | | | 57.43 | 20.55 | 20.68 |
| 3.5a | 58.80 | 15.03 | 20.67 | 61.09 | 13.97 | 20.40 | 59.95 | 14.50 | 20.54 |
| 3.5b | 59.69 | 13.76 | 20.64 | 61.92 | 12.84 | 20.32 | 60.81 | 13.30 | 20.48 |
| 3.5 (AVG) | | | | | | | 60.38 | 13.90 | 20.51 |
| 3.4a | 57.06 | 14.59 | 20.62 | 61.79 | 12.73 | 20.14 | 59.43 | 13.66 | 20.38 |
| 3.4b | 57.96 | 14.49 | 20.82 | 60.16 | 13.60 | 20.54 | 59.06 | 14.05 | 20.68 |
| 3.4 (AVG) | | | | | | | 59.24 | 13.85 | 20.53 |
| 3.3a | 61.58 | 12.33 | 20.52 | 65.48 | 10.78 | 19.50 | 63.53 | 11.56 | 20.01 |
| 3.3b | 58.78 | 13.62 | 20.84 | 61.65 | 12.45 | 20.38 | 60.22 | 13.04 | 20.61 |
| 3.3 (AVG) | | | | | | | 61.87 | 12.30 | 20.31 |
| 3.3 to 3.8a | 57.77 | 19.36 | 20.46 | 59.37 | 18.39 | 20.45 | 58.57 | 18.88 | 20.46 |
| 3.3 to 3.8b | 57.61 | 16.67 | 20.56 | 57.47 | 16.70 | 20.56 | 57.54 | 16.69 | 20.56 |
| 3.3 to 3.8 | | | | | | | 58.06 | 17.78 | 20.51 |
| (AVG) | | | | | | | | | |

### Example 4

### Reduced Sodium

The sodium contents of regular store bought beef (85% lean ground) and pork (chops) determined and compared those to Lean Finely Textured Beef produced commercially using the process of U.S. Pat. No. 5,871,795 and Lean Cold Processed Beef and Pork. Sodium content was analyzed using an ICP sample preparation and the emission spectrometry method described in AOAC 984.27. Although the HCl and NaOH combine to create water and salt, the salt content of the treated meat is comparable to the untreated meat. It was found through experimentation that the average sodium content of untreated beef is 68.38 mg/100 g and untreated pork is 74.18 mg/100 g. A sample of Lean Finely Textured Beef was found to have 122 mg/100 g. The sodium content in the Lean Cold Processed Beef was 46 mg/100 g and Lean Cold Processed Pork was 71.80 mg/100 g.

As shown in Table 6, the protein samples processed at pH 3.6, 3.8 and 5.8 have a red color while the protein samples processed at pH 3.3, 3.4 and 3.5 have a brown color. In addition, the protein sample processed at pH 3.3 and then having its pH increased to pH 3.8 retained its brown color initially produced at 3.3. Thus, the production of brown color product cannot be converted to a red color product.

### Example 5

### Fat Oxidation

To examine the extent of oxidation that had occurred to the phase, the thio-barbituric acid reactive substance (TBARS) procedure described by Lemon (1975) (Lemon, D. W. 1975 An Improved TBA test for rancidity, News Series Circular No. 51, Halifax Laboratory, Scotia, Canada). For the control fat from fresh ground beef (80:20) was extracted, mixed with water and placed into a sealed poly bag which was further placed into a water bath at 107° F. After 30 minutes, the mixture was centrifuged for 20 minutes at 3,000×g in a Sorval centrifuge. The lipid phase was drained off and the lipid was placed into Whirl-pak bags and stored at refrigerated temperatures (34-40° F.) for seven days prior to TBARS analysis. This control is how the industry currently produces Lean Finely Textured Beef and the fat phase from this process. Beef fat from the Lean Cold Processed Meat process is extracted using the procedure described above and 1) was placed into Whirl-pak bags and stored at refrigerated temperatures (34-30° F.) for seven days prior to TBARS analysis or was 2) mixed with cold water 50:50 (w/w) and then stored at refrigerated temperatures (34-40° F.) for seven days prior to TBARS analysis.

Controls had a value of 14.25±3.5 nmol/kg of TBARS whereas the (dry) fat samples were found at 64±2.1 nmol/kg and the fat in water samples were found to be 2.7±2.0 nmol/kg. In subsequent experiments the moisture content of the (dry) fat is 26.92% moisture with a peroxide value of 0.25 meq/kg, and the fat with water sample to be 57.31% moisture with a peroxide number of <0.02 meq/kg. Peroxides were measured using the Peroxy Safe method (AOAC 03050). Controls had extensive oxidation when compared to Lean Cold Processed Fat samples. It is peculiar that the fat samples stored with water had lower oxidation values than the fat stored dry. Typically higher moisture contents in fats leads to higher rates of oxidation. It may be that there was so much water that it diluted out the pre-oxidants and made the oxidation reactions less active.

### Example 6

Lean Cold Processed Beef was made for comparison purposes using 1. hydrochloric acid and sodium hydroxide and 2. citric acid and sodium bicarbonate. Ground beef trim was mixed with cold water at a 1:4 ratio of beef to water. The mixture was homogenized using a Kitchen Aid hand-held mixer for 1 minute on high speed. One aliquot was reduced to pH 3.6 using 2N HCl and another aliquot had its pH adjusted to pH 3.6 using 2N citric acid. The resultant products were filtered through a metal screen with 1/16 inch perforations. Both filtrates were adjusted to pH 5.5 using 4M sodium hydroxide (HCl sample) or 6% (w/w) sodium bicarbonate (citric acid sample). Product was filtered again to remove water. The final pH of the final product was adjusted to pH 6.5 using additional sodium hydroxide or sodium bicarbonate. Product was frozen and sent to Silliker Laboratories for proximate and sodium analyses.

TABLE 7
Analytical Data for Lean Cold Processed
Beef made using Different Acids and Bases

| Analyte | Result | Method |
|---|---|---|
| HCL/NaOH | | |
| Ash | 0.23 | AOAC 920.153 |
| Carbohydrate | 0.74 | Calculation |
| Fat | 4.68 | AOAC 960.39 |
| Moisture | 79.60 | AOAC 991.46Bb |
| Protein | 14.75 | AOAC991.20.1 |
| Salt | 0.17 | AOAC 983.14 |
| Citric/Sodium bicarbonate | | |
| Ash | 0.31 | AOAC 920.153 |
| Carbohydrate | .033 | Calculation |
| Fat | 4.49 | AOAC 960.39 |
| Moisture | 80.15 | AOAC 991.46Bb |
| Protein | 14.72 | AOAC991.20.1 |
| Salt | 0.05 | AOAC 983.14 |

Results demonstrates that both acid/base combinations produce final products that meet USDA chemical specifications for Lean Finely Textured Beef (LFTB) of >14% protein and <10% fat. Both samples were also reddish/pink in color which is also a USDA requirement for LFTB and both had a mild beef taste with no off-tastes or odors.

### Example 7

### Sturdiness

Fresh beef (85% lean) was placed into a mixing container and cold water was added at a 1:4 ratio (beef:water). The mixture was homogenized using a Kitchen Aid hand mixer on high speed for 2 min. The homogenate was then adjusted to pH 3.6 using hydrochloric acid (2M). Product was centrifuged in a Sorvall Model RC-5B centrifuge for 20 minutes at 8,000 RPM. The acidified solution was accurately adjusted, by the addition of cold water, to 2.5% Brix using a hand-held refractometer. A sample of the starting material was taken. Two gallons of the remaining solution was placed into a ultrafiitration test unit (Koch Membrane, Wilmington, Mass.) equipped with a 720034 column for water removal. Product was run for 1.05 hrs until the refractometer displayed a reading of 5% Brix. Individually the products were adjusted to pH 5.5 using sodium hydroxide (4M) and the precipitates were collected for analysis.

The precipitated products made from the 2.5% Brix and 5.0% Brix solutions were measured for fiber length development and sturdiness of the fibers. Sturdiness was determined by placing equal 200 g beef weights (minus the water weights) on a 1000 micron screen and swirling under constant motion for 2 minutes before weighing the resultant retentate.

The fiber length of precipitated product made from the starting solution of 2.5% Brix ranged between 0.5 to 1.0 mm, compared to the fiber length made from 5% Brix material which ranged from 1.5% Brix to 5 mm in length. The smaller size of the 2.5% Brix particles required centrifugation to effectively collect the precipitate, whereas the larger fibers were collected in a 1/16 inch wire screen.

To determine sturdiness the average weights of the precipitated products after the swirling filtering step were taken. The results were 127 g from the 5% Brix solution and 82 g from the 2.5% Brix solutions. This represents a 54.9% increase in yield if one captures the precipitated product from a 5% Brix solution versus obtaining the same product from a 2.5% solution. We refer this as sturdiness because what appears to happen with the product from the 2.5% solution, is that the swirling motion causes a shearing of the product which reduces its particle size and allows more to pass through the 1000 micron screen. The swirling shear action appears to not be able to reduce the particle size of the 5% Brix product.

### Example 8

### Beef Adjusted to Alkaline pH, Moderate Heat Conditions Prior to Isoelectric Precipitation

Fresh, beef (eye round) was obtained at a local store. The beef was ground through a ½ inch plate on a meat grinder. Water was added to the ground beef at a ratio of 1 part beef to 2 parts water. The beef mixture was homogenized using a Kitchen Aid hand mixer for 1 minute. The slurry was adjusted to pH 10.0 using sodium carbonate (0.65%) added as a crystal to solubilized the protein. The pH adjusted beef solution (pH 9.48) was heated in a large pot on a heating burner while constantly stirring and the solid fat turned into liquid fat. The product was heated to 105° F. as measured using an infra-red thermometer and double checked with a digital thermometer. Once the desired temperature of 105° F. was achieved the product was removed from the heat and placed into a refrigerator to chill. The chilled beef was further pH adjusted to pH 5.96 using crystallized, anhydrous, citric acid (0.60%). The solution was gently stirred to allow the proteins to precipitate out of solution. The precipitated beef was allowed to drain in a stainless steel filter with approximately 1 mm holes. The material was dewatered to a moisture content of 80.7%.

The precipitated beef was analyzed for color (L*,a*,b*) using a handheld colorimeter D65; 10°; with a 8 mm aperture. The precipitated protein was also evaluated for water binding ability using the centrifugal method of Hand, et al (1985).

To test the water binding ability (WBA), the procedure of Hand et. al. (1985) was used. Twenty five (25) grams of protein were placed into pre-weighed, 250 ml Nalgene Centrifuge bottles. Then 50 grams of 2° C. distilled water were added to each of the centrifuge bottles. The bottles were consistently and vigorously shaken by hand for 30 seconds and then centrifuged at 2° C. using a DuPont Sorvall RC-5B refrigerated centrifuge at 3,000 rpm for 10 minutes. The centrifuge bottles were then removed and immediately inverted over an approximate 1000 mesh wire screen for 1 minute. Transfer of any solids that may have fallen from the tube onto the screen were put back into the tube and the tube was then re-weighed.

WBA=[wgt.(g) of chicken after centrifuge/wgt.(g) initial chicken]×100
Reference: Hand, L. W., Calkins, C. R. and Mandigo, R. W. 1985 A technique to measure the water uptake properties of meat. Paper no. 202, presented at the 77^{th} Annual Meeting of the American Society of Animal Science, Athens Ga., August 13-16.

TABLE 8
L*, a*, b* Colorimeter (CIE) Values of Control Beef and Precipitated Heated (105° F.) Beef.

| | L* | a* | b* | L* | a* | b* | L* | a* | b* | L* | a* | b* | L* | a* | b* |
|---|---|---|---|---|---|---|---|---|---|---|---|---|---|---|---|
| | (1) | (1) | (1) | (2) | (2)′ | (2) | (3) | (3) | (3) | (4) | (4) | (4) | (AVG) | (AVG) | (AVG) |
| Control | 74.81 | 20.88 | 14.34 | 73.08 | 16.59 | 10.78 | 74.76 | 18.36 | 12.23 | 73.02 | 19.28 | 13.27 | 73.92 | 18.74 | 12.56 |
| Heated | 73.82 | 29.11 | 6.80 | 74.11 | 28.56 | 7.41 | 73.48 | 28.44 | 7.51 | 74.02 | 29.62 | 7.48 | 73.86 | 28.84 | 7.11 |
| PPt. | | | | | | | | | | | | | | | |
| Beef | | | | | | | | | | | | | | | |

Results

From the results in Table 8 it can be seen that there was large increase in a* values and a smaller but observable decrease in b* value. This would point to a beef sample that was more “red” and more “blue” in color than control, fresh, ground beef. Increasing the blue value resulted in a slight red-purplish color in the finished product which appeared close to the color of vacuum packaged beef.

TABLE 9
Water Binding Ability of Control Beef and Heated Alkaline Beef
Ground Beef Control

| | | | | | Wgt | |
|---|---|---|---|---|---|---|
| | | Total | Initial | Wgt. after | beef after | |
| | Total | tube plus | Beef | Centrifuge | centrifuge | |
| Sample | tube (g) | beef (g) | Wgt (g) | (g) | (g) | WBA |
| 1 | 109.25 | 134.51 | 25.26 | 136.44 | 27.19 | 107.64 |
| 2 | 106.34 | 131.56 | 25.22 | 133.87 | 27.53 | 109.16 |
| 3 | 109.78 | 135.00 | 25.22 | 137.64 | 27.86 | 110.47 |
| 4 | 109.86 | 135.34 | 25.48 | 138.09 | 28.23 | 110.79 |
| 5 | 106.74 | 131.79 | 25.05 | 134.14 | 27.4 | 109.38 |
| 6 | 106.44 | 131.59 | 25.15 | 134.27 | 27.83 | 110.66 |
| | | | | | Average | 109.68 |

TABLE 10
Alkaline Beef Heated to 105° F.

| | | | | | Wgt | |
|---|---|---|---|---|---|---|
| | | Total | Initial | Wgt. after | beef after | |
| | Total | tube plus | Beef | Centrifuge | centrifuge | |
| Sample | tube (g) | beef (g) | Wgt (g) | (g) | (g) | WBA |
| 7 | 106.85 | 131.99 | 25.14 | 136.49 | 29.64 | 117.90 |
| 8 | 109.76 | 134.67 | 24.91 | 139.67 | 29.91 | 120.07 |
| 9 | 106.28 | 131.24 | 24.96 | 136.17 | 29.89 | 119.75 |
| 10 | 106.33 | 131.56 | 25.23 | 136.87 | 30.54 | 121.05 |
| 11 | 109.67 | 135.47 | 25.80 | 140.25 | 30.58 | 118.53 |
| 12 | 109.21 | 134.97 | 25.76 | 139.85 | 30.64 | 118.94 |
| | | | | | Average | 119.37 |

The results of Table 10 show an improvement in functionality of the heated alkaline beef precipitate versus the control as measured by water binding ability. This is consistent with past observances on heating in acid soluble range.

### Example 9

### Settings for Lean Coarse Pressed Beef

The method described in FIG. 2 was used with the settings below. The starting material was 30% lean, 70% fat beef trimmings. The percent of the fat, moisture and protein are the amounts of the protein product after undergoing the process described in FIG. 2. As can be seen, the protein product has less than 7% fat and about 20% lean protein, while retaining moisture.

| | First | Second | CEM | CEM | CEM |
|---|---|---|---|---|---|
| pH | pH | pH | Fat | Moisture | Protein |
| Order | Value | Value | (%) | (%) | (%) |
| Low to | 4.0 | 8.6 | NA | NA | NA |
| High * | | | | | |
| High to | 8.6 | 7.8 | 6.37 | 72.61 | 20.34 |
| Low * | | | | | |
| Low to | 3.8 | 6.5 | 4.95 | 73.70 | 20.65 |
| High ** | | | | | |
| Low to | 3.4 | 6.0 | 3.95 | 74.48 | 20.87 |
| High ** | | | | | |
| High to | 8.6 | 6.7 | 7.33 | 71.86 | 20.13 |
| Low ** | | | | | |

*CEM—CEM Corporation, Matthews, NC
Pump rate 4 gal/min
Differential 17 * Alfa Laval Three-phase decanter centrifuge
Differential 21 ** Alfa Laval Three-phase decanter centrifuge
Temperature target on all 102-107° F.
High pH adjustment first produced a color that was more red/pink than when low pH was first.

The terms, comprise, include, and/or plural forms of each are open ended and include the listed items and can include additional items that are not listed. The phrase “And/or” is open ended and includes one or more of the listed items and combinations of the listed items.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

1) A process for recovering uncooked, lean protein composition having a color of 75 to 52 L*, 32 to 15 a*, and 23 to 7 b* from animal muscle tissue having an average fat content between about 50% and 85% by weight and a lean content between about 50% and about 15% by weight, said process comprising the steps of:
a) adding water to animal muscle tissue and comminuting, homogenizing or mixing the animal muscle tissue and water to obtain an animal muscle tissue preparation;
b) adding a food grade alkali to the animal muscle tissue preparation from Step a) to effect a pH in the range of 8.3 to 10.5 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) adding a food grade acid to the heated solution of Step c) to decrease the pH to a range between 4.8 to 7.5 to obtain a suspension having at least precipitated protein, liquid fat and water;
e) after addition of the food grade acid in Step d), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

2) The process of claim 1, wherein water is added in Step a) in a ratio between about 1:0.5 animal muscle tissue to water and about 1:2 animal muscle tissue to water.

3) The process of claim 1 wherein said pH in Step b) is in the range of 9.0 to 10.0.

4) The process of claim 1 wherein the food grade alkali of Step b) is sodium bicarbonate, sodium carbonate, potassium bicarbonate, potassium carbonate, or sodium hydroxide.

5) The process of claim 1 wherein said food grade acid of Step d) is taken from the group of citric acid, ascorbic acid, phosphoric acid and hydrochloric acid.

6) The process of claim 1 wherein said pH in Step d) is in the range of 5.2 to 6.2.

7) The process of claim 1, wherein in Step c), the solubilized protein is heated to a temperature between about 95 and 105° F.

8) The process of claim 1, wherein the precipitated protein composition less than 10% by weight fat.

9) The process of claim 1, wherein the precipitated protein composition less than 5% by weight fat.

10) The process of claim 1, wherein the precipitated protein composition less than 3% by weight fat.

11) The process of claim 1, wherein the precipitated protein composition has about 0% by weight fat.

12) The process of claim 1, wherein Step e) performed by centrifugation, filtration, decantation.

13) The process of claim 1, wherein removing the precipitated protein composition from the suspension of Step e) comprises a two-way separation wherein precipitated protein is separated from a liquid phase having at least liquid fat and water.

14) The process of claim 13, further comprising the step of performing a second two-way separation wherein the liquid phase is separated into liquid fat and water.

15) The process of claim 1, wherein removing the precipitated protein composition from the suspension of Step e) comprises a three-way separation wherein the precipitated protein, the liquid fat and the water are separated.

16) The process of claim 1, wherein the precipitated protein composition has a color of 75 to 52 L*, 25 to 15 a*, and 23 to 16 b*.

17) The process of claim 1, wherein the precipitated protein composition has functionality of raw meat as measured from a measurement selected from the group consisting of: water binding test, meat emulsion test, moisture retention test and a combination thereof.

18) A process for recovering uncooked, lean protein composition having a color of 75 to 52 L*, 32 to 15 a*, and 23 to 7 b* from animal muscle tissue having an average fat content between about 50% and 85% by weight and a lean content between about 50% and about 15% by weight, said process comprising the steps of:
a) adding water to animal muscle tissue and comminuting, homogenizing or mixing the animal muscle tissue and water to obtain an animal muscle tissue preparation;
b) adding a food grade acid to the animal muscle tissue preparation from Step a) to effect a pH in the range of 3.6 to 4.4 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) adding a food grade alkali to the heated solution of Step c) to increase the pH to a range between 4.8 to 7.5 to obtain a suspension having at least precipitated protein, liquid fat and water;
e) after addition of the food grade acid in Step d), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

19) The process of claim 18, wherein water is added in Step a) in a ratio between about 1:0.5 animal muscle tissue to water and about 1:2 animal muscle tissue to water.

20) The process of claim 18, wherein said pH in Step b) is in the range of 3.6 to 3.8.

21) The process of claim 18, wherein said food grade acid in Step b) is taken from the group of citric acid, ascorbic acid, phosphoric acid and hydrochloric acid.

22) The process of claim 18, wherein the food grade alkali Step d) is sodium bicarbonate, sodium carbonate, potassium bicarbonate, potassium carbonate, sodium hydroxide.

23) The process of claim 18, wherein said pH in Step d) is in the range of 5.2 to 6.2.

24) The process of claim 18, wherein in Step c), the solubilized protein is heated to a temperature between about 95 and 105° F.

25) The process of claim 18, wherein the precipitated protein composition less than 10% by weight fat.

26) The process of claim 18, wherein the precipitated protein composition less than 5% by weight fat.

27) The process of claim 18, wherein the precipitated protein composition less than 3% by weight fat.

28) The process of claim 18, wherein the precipitated protein composition has about 0% by weight fat.

29) The process of claim 18, wherein Step e) performed by centrifugation, filtration, decantation.

30) The process of claim 18, wherein removing the precipitated protein composition from the suspension of Step e) comprises a two-way separation wherein precipitated protein is separated from a liquid phase having at least liquid fat and water.

31) The process of claim 30, further comprising the step of performing a second two-way separation wherein the liquid phase is separated into liquid fat and water.

32) The process of claim 18, wherein removing the precipitated protein composition from the suspension of Step e) comprises a three-way separation wherein the precipitated protein, the liquid fat and the water are separated.

33) The process of claim 18, wherein the precipitated protein composition has a color of 75 to 52 L*, 25 to 15 a*, and 23 to 16 b*.

34) The process of claim 18, wherein the precipitated protein composition has functionality of raw meat as measured from a measurement selected from the group consisting of: water binding test, meat emulsion test, moisture retention test and a combination thereof.

35) The process of claim 18, wherein the process further comprises cooling the precipitated protein composition

36) A process for recovering uncooked, lean protein composition having a color of 75 to 52 L*, 32 to 15 a*, and 23 to 7 b* from animal muscle tissue having an average fat content between about 50% and 85% by weight and a lean content between about 50% and about 15% by weight, said process comprising the steps of:
a) adding water to animal muscle tissue and comminuting, homogenizing or mixing the animal muscle tissue and water to obtain an animal muscle tissue preparation;
b) adding a food grade alkali to the animal muscle tissue preparation from Step a) to effect a pH in the range of 8.3 to 10.5 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) after heating in step c), removing liquid fat from the heated solution to obtain solubilized protein and water solution;
e) adding a food grade acid to the solubilized protein and water solution of Step d) to decrease the pH to a range between 4.8 to 7.5 to obtain a suspension having at least precipitated protein and water;
f) after addition of the food grade acid in Step e), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

37) The process of claim 36, further comprising, after Step d), cooling the solubilized protein and water solution.

38) The process of claim 36, wherein the precipitated protein composition has a color of 75 to 52 L*, 25 to 15 a*, and 23 to 16 b*.

39) A process for recovering uncooked, lean protein composition having a color of 75 to 52 L*, 32 to 15 a*, and 23 to 7 b* from animal muscle tissue having an average fat content between about 50% and 85% by weight and a lean content between about 50% and about 15% by weight, said process comprising the steps of:
a) adding water to animal muscle tissue and comminuting, homogenizing or mixing the animal muscle tissue and water to obtain an animal muscle tissue preparation;
b) adding a food grade acid to the animal muscle tissue preparation from Step a) to effect a pH in the range of 3.6 to 4.4 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) after heating in step c), removing liquid fat from the heated solution to obtain solubilized protein and water solution;
e) adding a food grade alkali to the solubilized protein and water solution of Step d) to increase the pH to a range between 4.8 to 7.5 to obtain a suspension having at least precipitated protein and water;
f) after addition of the food grade acid in Step e), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

40) The process of claim 39, further comprising, after Step d), cooling the solubilized protein and water solution.

41) The process of claim 39, wherein the precipitated protein composition has a color of 75 to 52 L*, 25 to 15 a*, and 23 to 16 b*.

42) An uncooked, lean protein composition having a color of 75 to 52 L*, 32 to 15 a*, and 23 to 7 b* obtained from animal muscle tissue having an average fat content between about 50% and 85% by weight and a lean content between about 50% and about 15% by weight, said product obtained from the process comprising the steps of:
a) adding water to animal muscle tissue and comminuting, homogenizing or mixing the animal muscle tissue and water to obtain an animal muscle tissue preparation;
b) adding a food grade alkali to the animal muscle tissue preparation from Step a) to effect a pH in the range of 8.3 to 10.5 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) adding a food grade acid to the heated solution of Step c) to decrease the pH to a range between 4.8 to 7.5 to obtain a suspension having at least precipitated protein, liquid fat and water;
e) after addition of the food grade acid in Step d), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

43) An uncooked, lean protein composition having a color of 75 to 52 L*, 32 to 15 a*, and 23 to 7 b* obtained from animal muscle tissue having an average fat content between about 50% and 85% by weight and a lean content between about 50% and about 15% by weight, said product obtained from the process comprising the steps of:
a) adding water to animal muscle tissue and comminuting, homogenizing or mixing the animal muscle tissue and water to obtain an animal muscle tissue preparation;
b) adding a food grade acid to the animal muscle tissue preparation from Step a) to effect a pH in the range of 3.6 to 4.4 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) adding a food grade alkali to the heated solution of Step c) to increase the pH to a range between 4.8 to 7.5 to obtain a suspension having at least precipitated protein, liquid fat and water;
e) after addition of the food grade acid in Step d), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

44) An uncooked, lean protein composition having a color of 75 to 52 L*, 32 to 15 a*, and 23 to 7 b* obtained from animal muscle tissue having an average fat content between about 50% and 85% by weight and a lean content between about 50% and about 15% by weight, said product obtained from the process comprising the steps of:
a) adding water to animal muscle tissue and comminuting, homogenizing or mixing the animal muscle tissue and water to obtain an animal muscle tissue preparation;
b) adding a food grade alkali to the animal muscle tissue preparation from Step a) to effect a pH in the range of 8.3 to 10.5 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) after heating in step c), removing liquid fat from the heated solution to obtain solubilized protein and water solution;
e) adding a food grade acid to the solubilized protein and water solution of Step d) to decrease the pH to a range between 4.8 to 7.5 to obtain a suspension having at least precipitated protein and water;
f) after addition of the food grade acid in Step e), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.

45) An uncooked, lean protein composition having a color of 75 to 52 L*, 32 to 15 a*, and 23 to 7 b* obtained from animal muscle tissue having an average fat content between about 50% and 85% by weight and a lean content between about 50% and about 15% by weight, said product obtained from the process comprising the steps of:
a) adding water to animal muscle tissue and comminuting, homogenizing or mixing the animal muscle tissue and water to obtain an animal muscle tissue preparation;
b) adding a food grade acid to the animal muscle tissue preparation from Step a) to effect a pH in the range of 3.6 to 4.4 to obtain a solubilized protein, fat and water mixture,
c) heating the solubilized protein and fat mixture to a temperature between about 84° F. and about 107° F. such that fat in the solubilized protein becomes a liquid form, to thereby obtain a heated solution that has at least solubilized protein, liquid fat and water;
d) after heating in step c), removing liquid fat from the heated solution to obtain solubilized protein and water solution;
e) adding a food grade alkali to the solubilized protein and water solution of Step d) to increase the pH to a range between 4.8 to 7.5 to obtain a suspension having at least precipitated protein and water;
f) after addition of the food grade acid in Step e), removing the precipitated protein composition from the suspension;
wherein the precipitated protein composition has a color of 75 to 52 L*, 32 to 15 a*, and 23 to 7 b*, and wherein the precipitated protein is an uncooked, lean protein having 14% or greater by weight protein and less than 30% by weight fat.
